(19) United States
(12) Patent Application Publication
(10) Pub. No.: US 2026/0039051 A1
(43) Pub. Date: Feb. 5, 2026

(54) ELECTRICAL CONNECTOR

(71) Applicant: CHENG UEI PRECISION INDUSTRY CO., LTD., New Taipei City (TW)

(72) Inventors: YUN WU, Dong-Guan City (CN); HSIN-MIN CHAO, New Taipei City (TW)

(21) Appl. No.: 19/006,202

(22) Filed: Dec. 30, 2024

(30) Foreign Application Priority Data
Aug. 1, 2024 (CN) 202421855261.7

(51) Int. Cl. H01R 13/502; H01R 13/405

(52) U.S. Cl. CPC H01R 13/502; H01R 13/405

(57) ABSTRACT

An electrical connector includes an insulating body, a central piece, a terminal assembly, an insulating housing, and a metal shell combined with the insulating housing. The central piece has a pair of bending arms. Each bending arm has a first rib and a second rib. The second rib extends frontward to form an extension arm. A front end of the extension arm is arched outward and then extends frontward to form a first bending tab. A front end of the first bending tab is bent inward to form a second bending tab. A tail end of the second bending tab extends inward to form a fixing tab. The terminal assembly is fastened in the insulating body. The central piece is fastened in a middle of the terminal assembly. The insulating body together with the central piece and the terminal assembly is housed in the insulating housing.

### CROSS REFERENCE TO RELATED APPLICATIONS

The present application is based on, and claims priority from, China Patent Application No. 202421855261.7, filed Aug. 1, 2024, the disclosure of which is hereby incorporated by reference herein in its entirety.

### BACKGROUND OF THE INVENTION

### Field of the Invention

The present invention generally relates to a connector, and more particularly to an electrical connector with an improved structural strength.

### Description of Related Art

Universal Serial Bus (USB) connectors are the most widely applied type of connectors among various types of the connectors frequently used in various electronic products, and the USB connectors include USB 2.0 connectors, USB 3.0 connectors, Micro USB connectors, Mini USB connectors, USB Type-C connectors and other specifications. The USB Type-C connector is able to charge and transmit data simultaneously, and an interface of the USB Type-C connector may be plugged in or withdrawn from a positive surface and a reverse surface of the USB Type-C connector, so a usage convenience is improved, and the USB Type-C connectors are widely used in the various electronic products.

Generally, a conventional electrical connector includes an insulating body, a terminal assembly and a central piece. The terminal assembly is fixed in the insulating body. and the central piece is located in a middle of the terminal assembly. The central piece has a main body, and a pair of bending arms vertically bent upward from two opposite sides of the main body. Each bending arm is equipped with a bending portion, an extension arm and a latching hook. The bending portion is bent from a rear end of one side edge of the main body. The extension arm includes a first extension part, a connecting part and a second extension part which are sequentially extended from a front end of the bending portion. The latching hook has a first bending tab bent outward and then extended frontward from a front end of the second extension part, a second bending tab extended frontward and then bent towards the main body from a front end of the first bending tab, and a third bending tab extended towards the main body and then bent towards the bending portion from a free end of the second bending tab.

However, in this structural design, the main body and the latching hook are unconnected, and a larger gap is formed between the main body and the pair of the bending arms, so a structural strength of a side surface of the central piece is insufficient. Moreover, when a frequent insertion condition and a frequent withdrawing condition are generated between the conventional electrical connector and a docking connector, the bending arms of the conventional electrical connector are broken and damaged easily. As a result, a signal transmission stability between the conventional electrical connector and the docking connector is affected.

In view of the above-mentioned drawbacks, it is necessary to provide an electrical connector with an improved structural strength.

### BRIEF SUMMARY OF THE INVENTION

An object of the present invention is to provide an electrical connector with an improved structural strength. The electrical connector includes an insulating body, a central piece, a terminal assembly, an insulating housing and a metal shell. The central piece is mounted in the insulating body. The central piece has a main board and a pair of bending arms. A front end and a rear end of the main board have a front plate portion and a rear plate portion, respectively. A width of the rear plate portion is wider than a width of the front plate portion. The pair of the bending arms are bent vertically from two middles of two outer side edges of the main board and extend to two fronts of the two outer side edges of the main board. Each bending arm has a first rib and a second rib which are housed in the insulating body. The first rib is vertically bent upward from one side of a front edge of the rear plate portion, and the second rib is vertically bent upward from one outer side edge of the front plate portion. A front end of the second rib extends frontward and along an extending direction of the front plate portion to form an extension arm exposed outside of the insulating body. A front end of the extension arm is arched outward and then extends frontward to form a first bending tab exposed outside of the insulating body. A front end of the first bending tab is bent inward and towards the front plate portion to form a second bending tab. A tail end of the second bending tab extends inward and towards the front plate portion to form a fixing tab. The fixing tab is connected to a front edge of the front plate portion. The second bending tabs and the fixing tabs of the pair of the bending arms are fixed in the insulating body. The terminal assembly is fastened in the insulating body. The central piece is fastened in a middle of the terminal assembly. The insulating body together with the central piece and the terminal assembly is housed in the insulating housing. The metal shell is combined with the insulating housing.

Another object of the present invention is to provide an electrical connector. The electrical connector includes an insulating body, a central piece mounted in the insulating body, a terminal assembly, an insulating housing and a metal shell. The central piece has a main board and a pair of bending arms. A front end and a rear end of the main board have a front plate portion and a rear plate portion, respectively. A width of the rear plate portion is wider than a width of the front plate portion. The pair of the bending arms are bent vertically from two middles of two outer side edges of the main board and extend to two fronts of the two outer side edges of the main board. Each bending arm has a bending portion. The bending portion has a first rib and a second rib which are housed in the insulating body. The first rib is vertically bent upward from one side of a front edge of the rear plate portion, and the second rib is vertically bent upward from one outer side edge of the front plate portion. A front end of the second rib extends frontward and along an extending direction of the front plate portion to form an extension arm exposed outside of the insulating body. A front end of the extension arm is arched outward and then extends frontward to form a first bending tab exposed outside of the insulating body. A front end of the first bending tab is bent inward and towards the front plate portion to form a second bending tab. A tail end of the second bending tab extends inward and towards the front plate portion to form a fixing tab. The fixing tab is connected to a front edge of the front plate portion. The second bending tabs and the fixing tabs of the pair of the bending arms are fixed in the insulating body. The extension arm, the first bending tab and the second bending tab of each bending arm, and the one outer side edge of the front plate portion together surround a hollow portion. The terminal assembly is fastened in the insulating body. The central piece is fastened in a middle of the terminal assembly. The insulating body together with the central piece and the terminal assembly is housed in the insulating housing. The metal shell is combined with the insulating housing.

Another object of the present invention is to provide an electrical connector. The electrical connector includes an insulating body, a central piece, a terminal assembly, an insulating housing and a metal shell. The central piece is mounted in the insulating body. The central piece has a main board, a pair of bending arms and a pair of holding tabs. A front end and a rear end of the main board have a front plate portion and a rear plate portion, respectively. A width of the rear plate portion is wider than a width of the front plate portion. The pair of the bending arms are bent vertically from two middles of two outer side edges of the main board and extend to two fronts of the two outer side edges of the main board. The pair of the holding tabs are vertically bent upward from two rear ends of the two outer side edges of the main board. Each bending arm has a bending portion. The bending portion has a first rib and a second rib which are housed in the insulating body. The first rib is vertically bent upward from one side of a front edge of the rear plate portion, and the second rib is vertically bent upward from one outer side edge of the front plate portion. A front end of the second rib extends frontward and along an extending direction of the front plate portion to form an extension arm exposed outside of the insulating body. A front end of the extension arm is arched outward and then extends frontward to form a first bending tab exposed outside of the insulating body. A front end of the first bending tab is bent inward and towards the front plate portion to form a second bending tab. A tail end of the second bending tab extends inward and towards the front plate portion to form a fixing tab. The fixing tab is connected to a front edge of the front plate portion. The second bending tabs and the fixing tabs of the pair of the bending arms are fixed in the insulating body. The pair of the holding tabs are exposed outside of two outer side surfaces of the insulating body. The terminal assembly is fastened in the insulating body. The central piece is fastened in a middle of the terminal assembly. The insulating body together with the central piece and the terminal assembly is housed in the insulating housing. The metal shell is combined with the insulating housing. The metal shell has a pair of holding portions extended rearward from two rear edges of two sides of the metal shell. The pair of the holding portions are exposed out of a rear end of the insulating housing. The pair of the holding portions are attached to two outer side surfaces of the pair of the holding tabs.

As described above, the electrical connector includes the insulating body, the terminal assembly disposed in the insulating body, and the central piece disposed in the middle of the terminal assembly. Furthermore, the central piece has the main board, and the pair of the bending arms bent vertically from the two middles of the two outer side edges of the main board and extend to the two fronts of the two outer side edges of the main board. The bending portion of each bending arm has the first rib and the second rib housed in the insulating body, the first rib is vertically bent upward from the one side of the front edge of the rear plate portion, and the second rib is vertically bent upward from the middle of the outer side edge of the front plate portion, the upper portion of the front end of the second rib extends along the extending direction of the front plate portion to form the extension arm exposed outside of the insulating body, the first bending tab is arched outward and then is extended frontward from the front end of the extension arm to be exposed outside of the insulating body, the second bending tab is bent inward and towards the front plate portion from the front end of the first bending tab, the fixing tab is extended inward and towards the front plate portion from the tail end of the second bending tab, the fixing tab is connected to the front edge of the front plate portion, and the second bending tab and the fixing tab are housed in the insulating body, so the central piece forms a three-dimensional structure. As a result, a connection area between each bending arm and the main board is increased through the fixing tab and the bending portion, and a structural strength of the electrical connector is enhanced.

### BRIEF DESCRIPTION OF THE DRAWINGS

The present invention will be apparent to those skilled in the art by reading the following description, with reference to the attached drawings, in which:

FIG. 1 is a perspective view of an electrical connector according to the present invention;

FIG. 2 is an exploded view of the electrical connector according to the present invention;

FIG. 3 is a perspective view of a central piece of the electrical connector according to the present invention;

FIG. 4 is an exploded view of the central piece and a terminal assembly of the electrical connector according to the present invention;

FIG. 5 is another exploded view of the central piece and the terminal assembly of the electrical connector according to the present invention;

FIG. 6 is a schematic view showing that a pair of grounding terminals are disposed on the central piece of the electrical connector according to the present invention;

FIG. 7 is a partially perspective view of the terminal assembly of the electrical connector according to the present invention; and

FIG. 8 is a perspective view of a metal shell of the electrical connector according to the present invention.

### DETAILED DESCRIPTION OF THE INVENTION

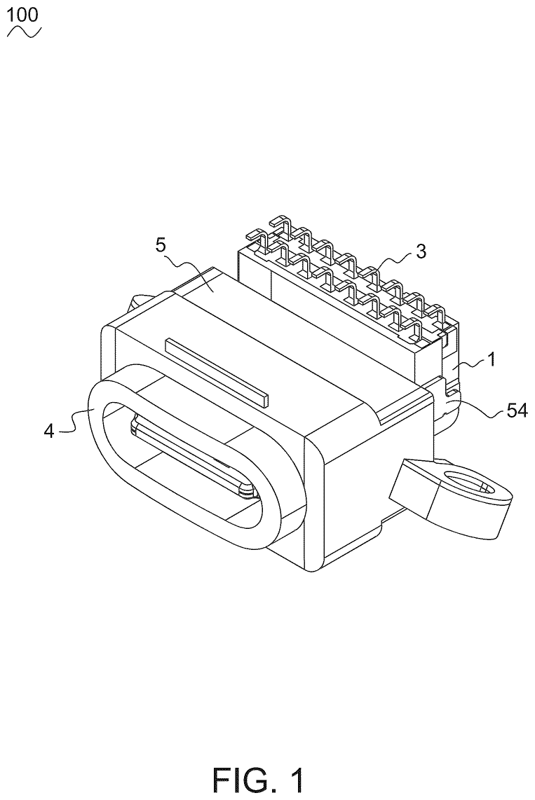

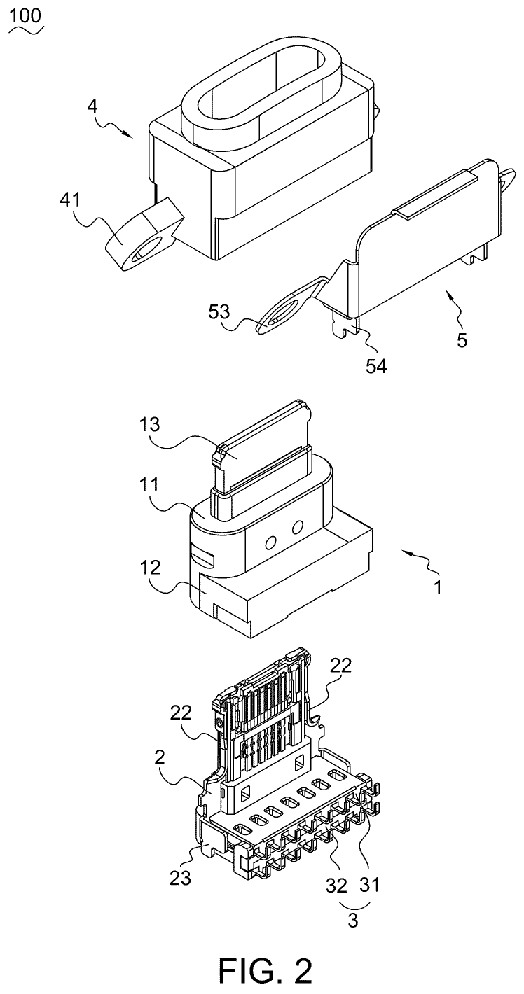

Referring to FIG. 1 and FIG. 2, an electrical connector 100 according to the present invention is shown. The electrical connector 100 is adapted for being docked with a docking connector (not shown). The electrical connector 100 includes an insulating body 1, a central piece 2 mounted in the insulating body 1, a terminal assembly 3 fastened in the insulating body 1, an insulating housing 4 and a metal shell 5. The central piece 2 is formed by continuously stamping a metal sheet, the central piece 2 is fastened in a middle of the terminal assembly 3, and the central piece 2 is integrated into the middle of the terminal assembly 3. The insulating body 1 encloses the central piece 2 and the terminal assembly 3, and the insulating body 1 together with the central piece 2 and the terminal assembly 3 is housed in the insulating housing 4. The metal shell 5 is combined with the insulating housing 4, and the metal shell 5 is fixed to the central piece 2. The electrical connector 100 is a Type-C connector. The electrical connector 100 is without being limited to be the Type-C connector.

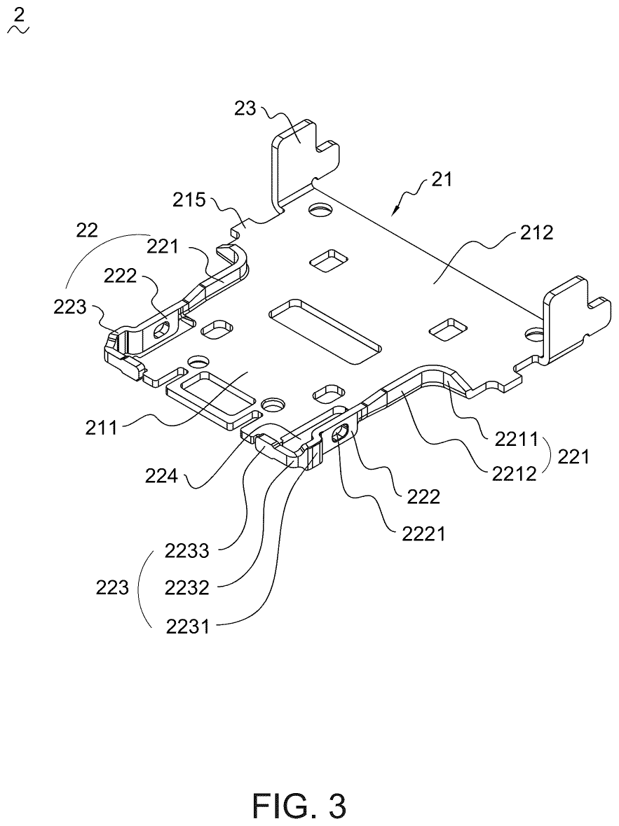

Referring to FIG. 2 and FIG. 3, the terminal assembly 3 includes an upper terminal assembly 31 and a lower terminal assembly 32. The central piece 2 is positioned between the upper terminal assembly 31 and the lower terminal assembly 32 to shield a signal interference. The central piece 2 has a main board 21, a pair of bending arms 22 and a pair of holding tabs 23. The pair of the bending arms 22 are bent vertically from two middles of two outer side edges of the main board 21 and extend to two fronts of the two outer side edges of the main board 21. Each bending arm 22 is shown as a Z shape. The pair of the holding tabs 23 are vertically bent upward from two rear ends of the two outer side edges of the main board 21. The pair of the bending arms 22 are symmetrically disposed at two opposite sides of the main board 21, and the pair of the holding tabs 23 are symmetrically disposed at the two opposite sides of the main board 21. In the present invention, the main board 21 is formed in a substantially T-shaped board structure. A front end and a rear end of the main board 21 have a front plate portion 211 and a rear plate portion 212, respectively. A middle of a front end of the rear plate portion 212 is connected with a rear end of the front plate portion 211. A width of the rear plate portion 212 is wider than a width of the front plate portion 211.

Each bending arm 22 has a bending portion 221, an extension arm 222 and a latching hook 223. The bending portion 221 of each bending arm 22 has a first rib 2211 and a second rib 2212 which are housed in the insulating body 1. The first rib 2211 is vertically bent upward from one side of a front edge of the rear plate portion 212, and the second rib 2212 is vertically bent upward from a middle of one outer side edge of the front plate portion 211. The first rib 2211 and the second rib 2212 are connected to show an L shape. An upper portion of a front end of the second rib 2212 extends frontward and then extends downward to form the extension arm 222. The upper portion of the front end of the second rib 2212 extends frontward and along an extending direction of the front plate portion 211 to form the extension arm 222 exposed outside of the insulating body 1.

Each latching hook 223 has a first bending tab 2231, a second bending tab 2232 and a fixing tab 2233. A front end of the extension arm 222 is arched outward and then extends frontward to form the first bending tab 2231 exposed outside of the insulating body 1. A front end of the first bending tab 2231 is bent inward and towards the front plate portion 211 to form the second bending tab 2232. A tail end of the second bending tab 2232 extends inward and towards the front plate portion 211 to form the fixing tab 2233. A width of the fixing tab 2233 is wider than a width of the second bending tab 2232. The fixing tab 2233 is connected to a front edge of the front plate portion 211 by a spot soldering way, so that the fixing tab 2233 is prevented from bouncing outward to enhance a structural strength of the bending arm 22. The second bending tab 2232 and the fixing tab 2233 are housed in the insulating body 1. In the present invention, the central piece 2 has at least one protrusion 215 extended outward from a front of an outer side edge of the rear plate portion 212. The at least one protrusion 215 is connected with a material strip (not shown) during a continuous stamping process. Specifically, two fronts of the two outer side edges of the rear plate portion 212 protrude outward to form two protrusions 215.

Referring to FIG. 1 to FIG. 3, the pair of the holding tabs 23 are vertically bent upward from the two rear ends of the two outer side edges of the rear plate portion 212, and the pair of the holding tabs 23 are exposed outside of two outer side surfaces of the insulating body 1. The metal shell 5 has a pair of holding portions 54 extended rearward from two rear edges of two sides of the metal shell 5. The pair of the holding portions 54 are exposed out of a rear end of the insulating housing 4. The pair of the holding portions 54 are attached to two outer side surfaces of the pair of the holding tabs 23 by a laser spot soldering way, so that a location and a fixation between the metal shell 5 and the insulating housing 4 are realized.

Referring to FIG. 2 and FIG. 3, the upper terminal assembly 31, the lower terminal assembly 32 and the central piece 2 are separately manufactured in advance. Then, the upper terminal assembly 31 and the lower terminal assembly 32 are respectively assembled to a top surface and a bottom surface of the central piece 2, and the insulating body 1 surrounds an outside of the upper terminal assembly 31, the lower terminal assembly 32 and the central piece 2 by an injection molding way.

The main board 21 is housed in the insulating body 1. The pair of the bending arms 22 are located outside of two sides of the terminal assembly 3. The bending portions 221 of the pair of the bending arms 22 are housed in the insulating body 1. The extension arms 222 of the pair of the bending arms 22 are exposed outside of two fronts of two sides of the insulating body 1. The first bending tabs 2231 of the pair of the bending arms 22 are exposed outside of the two sides of the insulating body 1, and the second bending tabs 2232 and the fixing tabs 2233 of the pair of the bending arms 22 are fixed in the insulating body 1. The extension arm 222, the latching hook 223 of each bending arm 22 and the one outer side edge of the front plate portion 211 together form a hollow portion 224. The extension arm 222, the first bending tab 2231 and the second bending tab 2232 of each bending arm 22, and the one outer side edge of the front plate portion 211 together surround the hollow portion 224. The hollow portion 224 is located in front of the front edge of the rear plate portion 212. The extension arm 222 has a through hole 2221 transversely penetrating through the extension arm 222. The through hole 2221 is communicated with the hollow portion 224. During an injection molding process, the hollow portion 224 and the through hole 2221 are filled with molten plastic to provide a better plastic flowability. After the plastic is solidified, the hollow portion 224 and the through hole 2221 provide a limiting function, so a combination between the central piece 2 and the insulating body 1 is stabler.

The electrical connector 100 enhances a structural strength of the electrical connector 100 by increasing a connection area between the pair of the bending arms 22 and the central piece 2. The first rib 2211 and the second rib 2212 are formed at the front edge of the rear plate portion 212 and the outer side edge of the front plate portion 211, respectively, so a connection area between the bending portion 221 of each bending arm 22 and the central piece 2 is increased. Additionally, the fixing tab 2233 is connected to the front edge of the front plate portion 211, a connection area between the latching hook 223 of each bending arm 22 and the central piece 2 is increased. The pair of the bending arms 22 and the main board 21 are perpendicular to each other, so that the central piece 2 forms a three-dimensional structure that enhances a side structural strength of the central piece 2. Therefore, when the docking connector is inserted into or withdrawn from the electrical connector 100, the terminal assembly 3 and the insulating body 1 effectively prevent causing a breakage and a deformation.

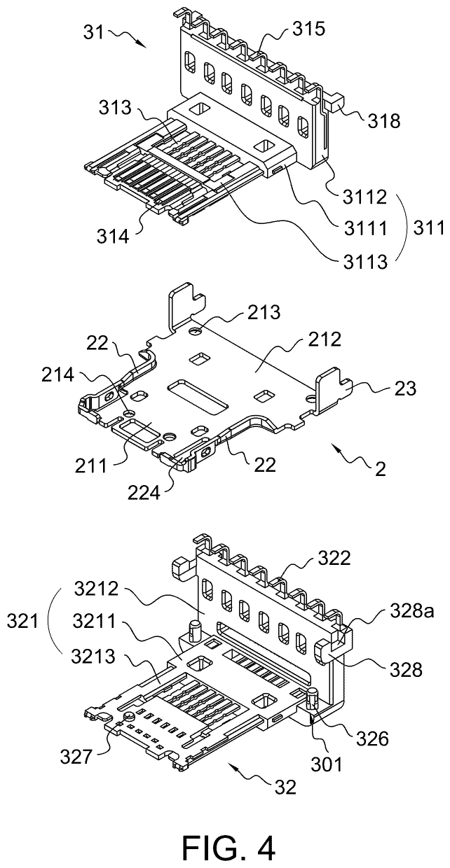

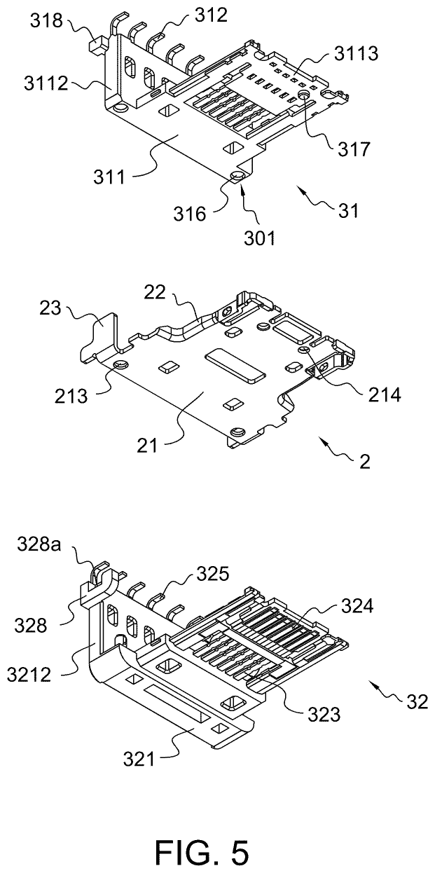

Referring to FIG. 4 and FIG. 5, the upper terminal assembly 31 includes an upper base body 311, and a plurality of upper terminals 312 embedded in the upper base body 311. The plurality of the upper terminals 312 are molded to the upper base body 311 by the injection molding way. The upper base body 311 has an upper base portion 3111, an upper base block 3112 and an upper tongue portion 3113. The upper base block 3112 is vertically extended upward from a rear end of the upper base portion 3111. The upper tongue portion 3113 is extended frontward from a front end of the upper base portion 3111.

Each upper terminal 312 has an upper fixing portion 313, an upper contacting portion 314 and an upper soldering portion 315. The upper fixing portions 313 of the plurality of the upper terminals 312 are embedded in the upper base portion 3111 and the upper tongue portion 3113. The upper contacting portion 314 is extended frontward from a front end of the upper fixing portion 313. The upper contacting portions 314 of the plurality of the upper terminals 312 are exposed to an upper surface of the upper tongue portion 3113 to make the plurality of the upper terminals 312 be electrically conductive with the docking connector. The upper soldering portion 315 is vertically extended upward and then is bent frontward from a rear end of the upper fixing portion 313. The upper soldering portions 315 of the plurality of the upper terminals 312 are embedded in the upper base block 3112, and top ends of the upper soldering portions 315 of the plurality of the upper terminals 312 are exposed out of a top of the upper base block 3112.

The upper terminal assembly 31 is mounted on the lower terminal assembly 32. The lower terminal assembly 32 includes a lower base body 321, and a plurality of lower terminals 322 embedded in the lower base body 321. The plurality of the lower terminals 322 are molded to the lower base body 321 by the injection molding way. The lower base body 321 has a lower base portion 3211, a lower base block 3212 and a lower tongue portion 3213. The lower base block 3212 is vertically extended upward from a rear end of the lower base portion 3211. The lower tongue portion 3213 is extended frontward from a front end of the lower base portion 3211. The upper base portion 3111 is mounted on the lower base portion 3211. The upper base portion 3111 is aligned with the lower base portion 3211. The upper tongue portion 3113 is positioned on the lower tongue portion 3213. The upper tongue portion 3113 is aligned with the lower tongue portion 3213. The upper base block 3112 is located in front of the lower base block 3212. The upper base block 3112 is aligned with the lower base block 3212.

Each lower terminal 322 has a lower fixing portion 323, a lower contacting portion 324 and a lower soldering portion 325. The lower fixing portions 323 of the plurality of the lower terminals 322 are embedded in the lower base portion 3211 and the lower tongue portion 3213. The lower contacting portion 324 is extended frontward from a front end of the lower fixing portion 323. The lower contacting portions 324 of the plurality of the lower terminals 322 are exposed to a lower surface of the lower tongue portion 3213 to make the plurality of the lower terminals 322 be electrically conductive with the docking connector. The lower soldering portion 325 is vertically extended upward and then is bent frontward from a rear end of the lower fixing portion 323. The lower soldering portions 325 of the plurality of the lower terminals 322 are embedded in the lower base block 3212, and the lower soldering portions 325 of the plurality of the lower terminals 322 are exposed out of a top of the lower base block 3212.

Referring to FIG. 4 and FIG. 5, in order to fix and limit the central piece 2, the upper terminal assembly 31 and the lower terminal assembly 32, the main board 21 has at least one first positioning hole 213 opened at a rear end of the rear plate portion 212, and at least one second positioning hole 214 opened at a front end of the front plate portion 211. Two sides of the rear end of the rear plate portion 212 open two first positioning holes 213 vertically penetrating through the rear plate portion 212. Two sides of the front end of the front plate portion 211 open two second positioning holes 214 vertically penetrating through the front plate portion 211. The terminal assembly 3 is equipped with a positioning structure 301 that is combined with the at least one first positioning hole 213 and the at least one second positioning hole 214. The upper terminal assembly 31 and the lower terminal assembly 32 are equipped with the positioning structure 301.

Additionally, two sides of the terminal assembly 3 has two latching blocks 318 and two latching units 328. The two latching blocks 318 are protruded outward from two outer sides of the upper base block 3112. The two latching units 328 are protruded outward and then are extended frontward from two outer sides of the lower base block 3212. Each latching unit 328 is shown as a U shape. A middle of a top of each latching unit 328 is recessed inward to form a latching slot 328a. The two latching blocks 318 are combined with the two latching slots 328a of the two latching units 328 to make the two latching blocks 318 buckled with the two latching units 328, so that the two latching blocks 318 are fixed with the two latching units 328.

In the present invention, the positioning structure 301 includes at least one concave hole 316 recessed inward from a bottom surface of the upper base block 3112, a protruding pillar 317 extended downward from a lower surface of the upper tongue portion 3113, at least one post 326 extended upward from an upper surface of the lower base portion 3211, and a bump 327 protruded upward from an upper surface of the lower tongue portion 3213. The at least one post 326 passes through the at least one first positioning hole 213. The at least one post 326 is aligned with the at least one concave hole 316, and the at least one post 326 is combined with the at least one concave hole 316. The protruding pillar 317 and the bump 327 are aligned with the two second positioning holes 214, respectively. The protruding pillar 317 and the bump 327 are combined with the two second positioning holes 214, respectively. Specifically, the positioning structure 301 includes two concave holes 316 recessed inward from two sides of the bottom surface of the upper base block 3112, the protruding pillar 317 extended downward from the lower surface of the upper tongue portion 3113, two posts 326 extended upward from two sides of the upper surface of the lower base portion 3211, and the bump 327 protruded upward from the upper surface of the lower tongue portion 3213. The two posts 326 pass through the two first positioning holes 213. The two posts 326 are aligned with the two concave holes 316, and the two posts 326 are combined with the two concave holes 316. The protruding pillar 317 and the bump 327 are aligned with the two second positioning holes 214, respectively. The protruding pillar 317 and the bump 327 are combined with the two second positioning holes 214, respectively.

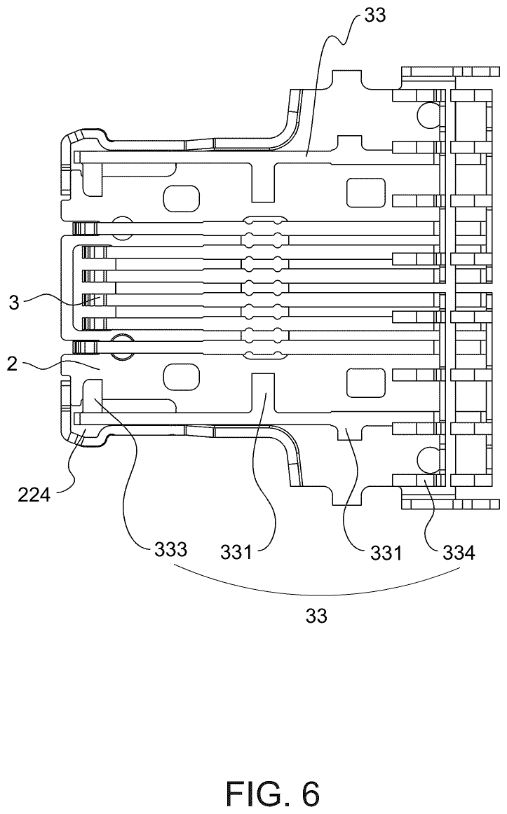

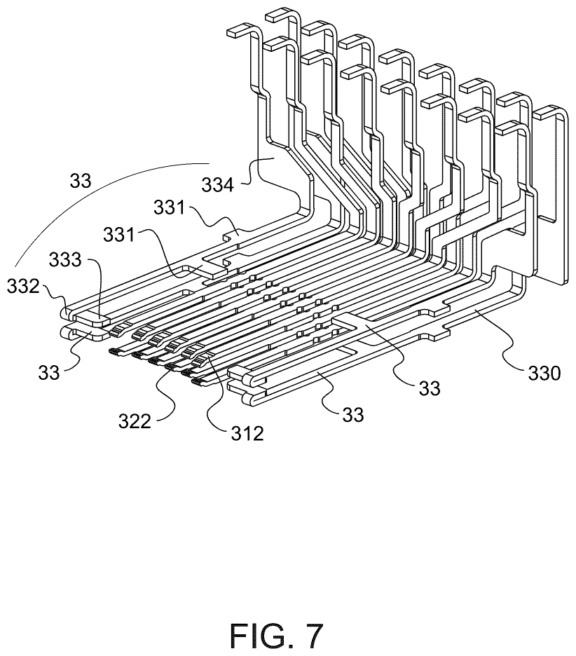

Referring to FIG. 2 to FIG. 7, the terminal assembly 3 includes two pairs of grounding terminals 33. The plurality of the upper terminals 312 include one pair of the grounding terminals 33. The plurality of the lower terminals 322 include the other pair of the grounding terminals 33. The one pair of the grounding terminals 33 are symmetrically mounted to two sides of a top of the central piece 2. The other pair of the grounding terminals 33 are symmetrically mounted to a bottom of the central piece 2. The one pair of the grounding terminals 33 are symmetrically disposed at two opposite sides of the upper terminal assembly 31, and the one pair of the grounding terminals 33 are located to two sides of the plurality of the upper terminals 312 in the upper terminal assembly 31. The other pair of the grounding terminals 33 are symmetrically disposed at two opposite sides of the lower terminal assembly 32, and the other pair of the grounding terminals 33 are located to two sides of the plurality of the lower terminals 322 in the lower terminal assembly 32.

Each grounding terminal 33 has a base bar 330, at least one protruding piece 331, a curving portion 332, a contacting piece 333 and a soldering section 334. The at least one protruding piece 331 is protruded outward from at least one side of the base bar 330. The at least one protruding piece 331 is combined with the base bar 330 of the terminal assembly 3. Specifically, two sides of the base bar 330 of each grounding terminal 33 protrude outward to form two protruding pieces 331. The at least one protruding piece 331 is designed to connect with a material band (not shown). A front edge of the base bar 330 of each grounding terminal 33 is bent downward and then extends rearward to form the curving portion 332. The curving portion 332 is combined with the base bar 330 of the terminal assembly 3. The curving portions 332 of the two pairs of the grounding terminals 33 are aligned with the two hollow portions 224 of the central piece 2. The contacting piece 333 is extended inward from an inner side of the curving portion 332. The contacting pieces 333 of the two pairs of the grounding terminals 33 are fastened to the central piece 2. The contacting pieces 333 of the two pairs of the grounding terminals 33 are soldered to the central piece 2 by the spot soldering way to realize a location and a fixation between the central piece 2 and the two pairs of the grounding terminals 33. The soldering section 334 is vertically bent upward and then is bent frontward from a rear end of the base bar 330, and the soldering sections 334 of the two pairs of the grounding terminals 33 are exposed outside of the terminal assembly 3.

Specifically, the base bar 330 of each grounding terminal 33 of the upper terminal assembly 31 includes the upper fixing portion 313 and the upper contacting portion 314, and the soldering section 334 of each grounding terminal 33 of the upper terminal assembly 31 is defined as the upper soldering portion 315. The base bar 330 of each grounding terminal 33 of the lower terminal assembly 32 includes the lower fixing portion 323 and the lower contacting portion 324, and the soldering section 334 of each grounding terminal 33 of the lower terminal assembly 32 is defined as the lower soldering portion 325. The protruding pieces 331 and the curving portions 332 of the grounding terminals 33 in the upper terminal assembly 31 are fixed in the upper base body 311. The protruding pieces 331 and the curving portions 332 of the grounding terminals 33 in the lower terminal assembly 32 are fixed in the lower base body 321. The soldering sections 334 of the grounding terminals 33 in the upper terminal assembly 31 are embedded in the upper base block 3112 and are exposed out of the top of the upper base block 3112. The soldering sections 334 of the grounding terminals 33 in the lower terminal assembly 32 are embedded in the lower base block 3212, and the soldering sections 334 of the grounding terminals 33 in the lower terminal assembly 32 are exposed out of the top of the lower base block 3212.

Referring to FIG. 2, FIG. 4 and FIG. 5, the insulating body I has a main body 11, a stepping portion 12 and a tongue board 13. The stepping portion 12 is vertically extended upward from a rear end of the main body 11, and the tongue board 13 is extended frontward from a middle of a front end of the main body 11. The main body 11 and the tongue board 13 are housed in the insulating housing 4. The stepping portion 12 is exposed out of the rear end of the insulating housing 4. The upper base portion 3111 and the lower base portion 3211 are positioned in the main body 11, the upper base block 3112 and the lower base block 3212 are positioned in the stepping portion 12, and the upper tongue portion 3113 and the lower tongue portion 3213 are positioned in the tongue board 13. The front plate portion 211 is located between the upper tongue portion 3113 and the lower tongue portion 3213, and the rear plate portion 212 is located between the upper base portion 3111 and the lower base portion 3211.

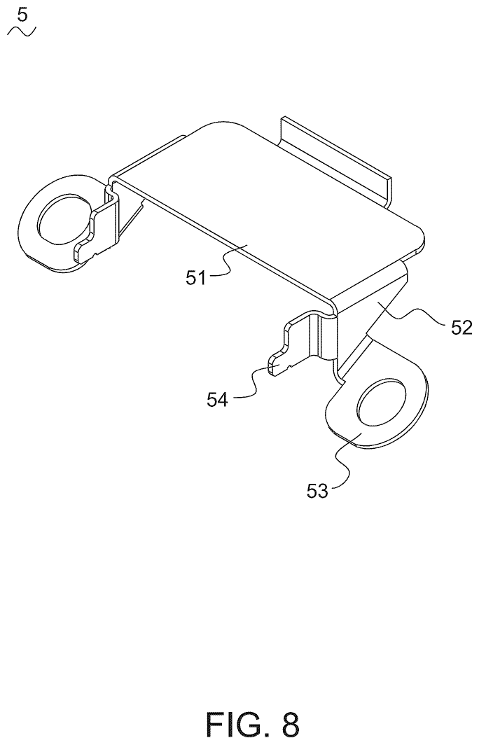

Referring to FIG. 2 and FIG. 8, the insulating housing 4 is a hollow plastic shell. Two outer side surfaces of the insulating housing 4 protrude outward to form a pair of lugs 41. The metal shell 5 has a base wall 51, a pair of side walls 52, a pair of wings 53 and the pair of the holding portions 54. The pair of the side walls 52 are bent downward from two sides of the base wall 51. The pair of the wings 53 are extended outward from two outer surfaces of the pair of the side walls 52. The pair of the wings 53 slantwise extend rearward and downward. The pair of the holding portions 54 are bent inward and then are extended rearward from two rear ends of the pair of the side walls 52. The insulating housing 4 is integrally assembled with the base wall 51 and the pair of the side walls 52 through the injection molding way. The pair of the wings 53 are aligned with the pair of the lugs 41, and lower surfaces of the pair of the wings 53 are attached to upper surfaces of the pair of the lugs 41.

As described above, the electrical connector 100 includes the insulating body 1, the terminal assembly 3 disposed in the insulating body 1, and the central piece 2 disposed in the middle of the terminal assembly 3. Furthermore, the central piece 2 has the main board 21, and the pair of the bending arms 22 bent vertically from the two middles of the two outer side edges of the main board 21 and extend to the two fronts of the two outer side edges of the main board 21. The bending portion 221 of each bending arm 22 has the first rib 2211 and the second rib 2212 housed in the insulating body 1, the first rib 2211 is vertically bent upward from the one side of the front edge of the rear plate portion 212, and the second rib 2212 is vertically bent upward from the middle of the outer side edge of the front plate portion 211, the upper portion of the front end of the second rib 2212 extends along the extending direction of the front plate portion 211 to form the extension arm 222 exposed outside of the insulating body 1, the first bending tab 2231 is arched outward and then is extended frontward from the front end of the extension arm 222 to be exposed outside of the insulating body 1, the second bending tab 2232 is bent inward and towards the front plate portion 211 from the front end of the first bending tab 2231, the fixing tab 2233 is extended inward and towards the front plate portion 211 from the tail end of the second bending tab 2232, the fixing tab 2233 is connected to the front edge of the front plate portion 211, and the second bending tab 2232 and the fixing tab 2233 are housed in the insulating body 1, so the central piece 2 forms the three-dimensional structure. As a result, a connection area between each bending arm 22 and the main board 21 is increased through the fixing tab 2233 and the bending portion 221, and the structural strength of the electrical connector 100 is enhanced.

What is claimed is:

1. An electrical connector, comprising:
an insulating body;
a central piece mounted in the insulating body, the central piece having a main board and a pair of bending arms, a front end and a rear end of the main board having a front plate portion and a rear plate portion, respectively, a width of the rear plate portion being wider than a width of the front plate portion, the pair of the bending arms being bent vertically from two middles of two outer side edges of the main board and extending to two fronts of the two outer side edges of the main board, each bending arm having a first rib and a second rib which are housed in the insulating body, the first rib being vertically bent upward from one side of a front edge of the rear plate portion, and the second rib being vertically bent upward from one outer side edge of the front plate portion, a front end of the second rib extending frontward and along an extending direction of the front plate portion to form an extension arm exposed outside of the insulating body, a front end of the extension arm being arched outward and then extending frontward to form a first bending tab exposed outside of the insulating body, a front end of the first bending tab being bent inward and towards the front plate portion to form a second bending tab, a tail end of the second bending tab extending inward and towards the front plate portion to form a fixing tab, the fixing tab being connected to a front edge of the front plate portion, the second bending tabs and the fixing tabs of the pair of the bending arms being fixed in the insulating body;
a terminal assembly fastened in the insulating body, the central piece being fastened in a middle of the terminal assembly;
an insulating housing, the insulating body together with the central piece and the terminal assembly being housed in the insulating housing; and
a metal shell combined with the insulating housing.

2. The electrical connector as claimed in claim 1, wherein the extension arm, the first bending tab and the second bending tab of each bending arm, and the one outer side edge of the front plate portion together surround a hollow portion.

3. The electrical connector as claimed in claim 2, wherein the extension arm has a through hole transversely penetrating through the extension arm, the through hole is communicated with the hollow portion.

4. The electrical connector as claimed in claim 1, wherein the central piece has a pair of holding tabs vertically bent upward from two rears of two outer side edges of the rear plate portion, the pair of the holding tabs are exposed outside of two outer side surfaces of the insulating body, the metal shell has a pair of holding portions extended rearward from two rear edges of two sides of the metal shell, the pair of the holding portions are exposed out of a rear end of the insulating housing, the pair of the holding portions are attached to two outer side surfaces of the pair of the holding tabs.

5. The electrical connector as claimed in claim 1, wherein the central piece has at least one protrusion extended outward from a front of an outer side edge of the rear plate portion.

6. The electrical connector as claimed in claim 1, wherein the main board has at least one first positioning hole opened at a rear end of the rear plate portion, and at least one second positioning hole opened at a front end of the front plate portion, the terminal assembly is equipped with a positioning structure that is combined with the at least one first positioning hole and the at least one second positioning hole.

7. The electrical connector as claimed in claim 1, wherein the terminal assembly includes an upper terminal assembly and a lower terminal assembly, the upper terminal assembly and the lower terminal assembly are equipped with a positioning structure.

8. The electrical connector as claimed in claim 7, wherein the upper terminal assembly includes an upper base body, and a plurality of upper terminals embedded in the upper base body, the upper base body has an upper base portion, an upper base block vertically extended upward from a rear end of the upper base portion, and an upper tongue portion extended frontward from a front end of the upper base portion, the lower terminal assembly includes a lower base body, and a plurality of lower terminals embedded in the lower base body, the lower base body has a lower base portion, a lower base block vertically extended upward from a rear end of the lower base portion, and a lower tongue portion extended frontward from a front end of the lower base portion, the upper base portion is mounted on the lower base portion, the upper base portion is aligned with the lower base portion, the upper base block is located in front of the lower base block, the upper base block is aligned with the lower base block, the upper tongue portion is positioned on the lower tongue portion, the upper tongue portion is aligned with the lower tongue portion, the front plate portion is located between the upper tongue portion and the lower tongue portion, and the rear plate portion is located between the upper base portion and the lower base portion.

9. The electrical connector as claimed in claim 8, wherein the positioning structure includes at least one concave hole recessed inward from a bottom surface of the upper base block, a protruding pillar extended downward from a lower surface of the upper tongue portion, at least one post extended upward from an upper surface of the lower base portion, and a bump protruded upward from an upper surface of the lower tongue portion, the main board has at least one first positioning hole opened at a rear end of the rear plate portion, two sides of a front end of the front plate portion open two second positioning holes vertically penetrating through the front plate portion, the at least one post passes through the at least one first positioning hole, the at least one post is aligned with the at least one concave hole, and the at least one post is combined with the at least one concave hole, the protruding pillar and the bump are aligned with the two second positioning holes, respectively, the protruding pillar and the bump are combined with the two second positioning holes, respectively.

10. The electrical connector as claimed in claim 8, wherein two sides of the terminal assembly has two latching blocks protruded outward from two outer sides of the upper base block, and two latching units protruded outward and then extended frontward from two outer sides of the lower base block, each latching unit is shown as a U shape, a middle of a top of each latching unit is recessed inward to form a latching slot, the two latching blocks are combined with the two latching slots of the two latching units to make the two latching blocks buckled with the two latching units, so that the two latching blocks are fixed with the two latching units.

11. The electrical connector as claimed in claim 8, wherein the insulating body has a main body, a stepping portion vertically extended upward from a rear end of the main body, and a tongue board extended frontward from a middle of a front end of the main body, the main body and the tongue board are housed in the insulating housing, the stepping portion is exposed out of a rear end of the insulating housing, the upper base portion and the lower base portion are positioned in the main body, the upper base block and the lower base block are positioned in the stepping portion, and the upper tongue portion and the lower tongue portion are positioned in the tongue board, the front plate portion is located between the upper tongue portion and the lower tongue portion, and the rear plate portion is located between the upper base portion and the lower base portion.

12. The electrical connector as claimed in claim 7, wherein the terminal assembly includes two pairs of grounding terminals, one pair of the grounding terminals are symmetrically mounted to two sides of a top of the central piece, the other pair of the grounding terminals are symmetrically mounted to a bottom of the central piece, the one pair of the grounding terminals are symmetrically disposed at two opposite sides of the upper terminal assembly, the other pair of the grounding terminals are symmetrically disposed at two opposite sides of the lower terminal assembly, each grounding terminal has a base bar and a contacting piece, a front edge of the base bar is bent downward and then extends rearward to form a curving portion, the contacting piece is extended inward from an inner side of the curving portion, the contacting pieces of the two pairs of the grounding terminals are fastened to the central piece.

13. The electrical connector as claimed in claim 1, wherein two outer side surfaces of the insulating housing protrude outward to form a pair of lugs, the metal shell has a base wall, a pair of side walls bent downward from two sides of the base wall, a pair of wings extended outward from two outer surfaces of the pair of the side walls, and a pair of holding portions bent inward and then extended rearward from two rear ends of the pair of the side walls, the pair of the wings slantwise extend rearward and downward, the insulating housing is integrally assembled with the base wall and the pair of the side walls, the pair of the wings are aligned with the pair of the lugs, and lower surfaces of the pair of the wings are attached to upper surfaces of the pair of the lugs.

14. The electrical connector as claimed in claim 1, wherein the first rib and the second rib are connected to show an L shape.

15. The electrical connector as claimed in claim 1, wherein each bending arm is shown as a Z shape.

16. An electrical connector, comprising:
an insulating body;
a central piece mounted in the insulating body, the central piece having a main board and a pair of bending arms, a front and a rear of the main board having a front plate portion and a rear plate portion, respectively, a width of the rear plate portion being wider than a width of the front plate portion to form a shoulder between the front plate portion and the rear plate portion, the pair of the bending arms being bent vertically from two middles of two outer side edges of the main board and extending to two fronts of the two outer side edges of the main board, each bending arm having a bending portion, the bending portion being continuously connected to the shoulder, the bending portion having a first rib and a second rib which are housed in the insulating body, the first rib being vertically bent upward from the shoulder along a transversely direction, and the second rib being vertically bent upward from the shoulder along a longitudinal direction, a front end of the second rib extending frontward and along the longitudinal direction to form an extension arm exposed outside of the insulating body, a front end of the extension arm being curved inward to form a latching hook exposed outside of the insulating body, a distal end of the latching hook being connected to a front edge of the front plate portion, the extension arm, the latching hook, and the an outer side edge of the front plate portion together surrounding a hollow portion;
a terminal assembly fastened in the insulating body, the central piece being fastened in a middle of the terminal assembly; and
an insulating housing, the insulating body together with the central piece and the terminal assembly being housed in the insulating housing, the insulating housing being filled in the hollow portion.

17. The electrical connector as claimed in claim 16, wherein the hollow portion is located in front of the front edge of the rear plate portion.

18. An electrical connector, comprising:
an insulating body;
a central piece mounted in the insulating body, the central piece having a main board, a pair of bending arms and a pair of holding tabs, a front end and a rear end of the main board having a front plate portion and a rear plate portion, respectively, a width of the rear plate portion being wider than a width of the front plate portion, the pair of the bending arms being bent vertically from two middles of two outer side edges of the main board and extending to two fronts of the two outer side edges of the main board, the pair of the holding tabs being vertically bent upward from two rear ends of the two outer side edges of the main board, each bending arm having a bending portion, the bending portion having a first rib and a second rib which are housed in the insulating body, the first rib being vertically bent upward from one side of a front edge of the rear plate portion, and the second rib being vertically bent upward from one outer side edge of the front plate portion, a front end of the second rib extending frontward and along an extending direction of the front plate portion to form an extension arm exposed outside of the insulating body, a front end of the extension arm being arched outward and then extending frontward to form a first bending tab exposed outside of the insulating body, a front end of the first bending tab being bent inward and towards the front plate portion to form a second bending tab, a tail end of the second bending tab extending inward and towards the front plate portion to form a fixing tab, the fixing tab being connected to a front edge of the front plate portion, the second bending tabs and the fixing tabs of the pair of the bending arms being fixed in the insulating body, the pair of the holding tabs being exposed outside of two outer side surfaces of the insulating body;
a terminal assembly fastened in the insulating body, the central piece being fastened in a middle of the terminal assembly;
an insulating housing, the insulating body together with the central piece and the terminal assembly being housed in the insulating housing; and
a metal shell combined with the insulating housing, the metal shell having a pair of holding portions extended rearward from two rear edges of two sides of the metal shell, the pair of the holding portions being exposed out of a rear end of the insulating housing, the pair of the holding portions being attached to two outer side surfaces of the pair of the holding tabs.
